(19) United States
(12) Patent Application Publication
(10) Pub. No.: US 2007/0038608 A1
(43) Pub. Date: Feb. 15, 2007

(54) Computer search system for improved web page ranking and presentation

(76) Inventor: Anjun Chen, Palo Alto, CA (US)

Correspondence Address: Anjun Chen, 748 Matadero Ave, Palo Alto, CA, 94306, US

(21) Appl. No.: 11/496,227

(22) Filed: Jul. 31, 2006

Related U.S. Application Data
(60) Provisional application No. 60/707,188, filed on Aug. 10, 2005.

(51) Int. Cl. G06F 17/30

(52) U.S. Cl. 707/3

(57) ABSTRACT

An Internet search system integrates additional concept-related information into a regular web search engine, providing better page ranking and richer presentation of search results. The additional information is directly related to the contents of the retrieved web pages but does not appear on the retrieved web pages and/or in the link structure. The new search system searches a conventional web page collection together with databases containing publications and semantic web data, which provides the aforesaid additional information.

### CROSS-REFERENCE TO RELATED APPLICATION

This application is based upon and claims the benefit of priority of U.S. Provisional Application No. 60/707,188, filed Aug. 10, 2005, the entire disclosure of which is incorporated herein by reference.

### FIELD OF THE INVENTION

The present invention relates to information retrieval systems, and, more specifically, to Internet search system, for generating and presenting search results based, at least in part, on additional information related to the contents of the retrieved documents.

### BACKGROUND OF THE INVENTION

Search engines are common tools for people to find relevant information on the Internet or Web. Usually, a user enters a simple search query consisting of one or more terms or keywords on a search site. The search engine then searches its indexes and returns a list of web pages that are in certain order computed by a ranking algorithm. Existing web page ranking algorithms take into account many factors like frequency and location of the search terms on the page, hyperlinks pointing to the page, and frequency of access to the page. These factors are all focused on information or metadata on the hyperlinked web pages.

Although ranking solely based on hyperlinked information reflects to some extend the relevancy of a page to a query, it also has limitations. This is because the fact that many relevant information pertaining to the page matching the query terms exist in documents other than the web page itself and the link structure. As a result, some important information may not be included in determining the page's relevancy and thus the resulted page ranking may not be optimal. For example, when searching for product information, product usage data is most relevant, but they are usually scattered in research publications.

Higher popularity of a web page does not always mean that the page is more relevant to the user. A highly relevant page may have only a few links pointing to it. If page popularity is the main factor in page ranking, this most relevant page will most likely be buried in search results. Another flaw of page ranking algorithm, which is based solely on the hyperlinked information, is the fact that it can be easily manipulated by invisible text on the retrieved page and/or by creating numerous junk inbound links.

Many strategies have been used to overcome the above mentioned drawbacks. These include applying logical grouping of related web sites or hierarchical taxonomy, using user profile or user feedback or document activation, or considering business rating or sales revenue in determining page rank. However, there are still many factors, particularly information that are independent of the text and metadata of the retrieved pages and the link popularity, remain outside of the scope of the existing search engines.

Therefore, there is a need to improve upon existing search engine technology in order to provide more relevant search results and more satisfactory search experience to users.

### SUMMARY OF THE INVENTION

One aspect of the present invention is to apply additional relevant information independent of the presentation of and hyperlinks to the retrieved web pages in order to improve ranking of the retrieved web pages. The invented Internet search system discovers the concept of each of the retrieved web pages and then searches additional databases for information relevant to that concept but not depending on how the retrieved page is presented and hyperlinked. The concept related information is then used in determining the final page rank, which results in more relevant and objective page ranking. The concept related information also provides comparison data, which enrich the content on the final presentation of the search results to user. In a particular application of such system for searching product information on the web, the additional databases can include a publication database consisting of published literature and semantic web data, and/or a product usage database built from text mining the publication database. Integrating literature data, semantic web data and usage information with traditional web search delivers more relevant and richer search results.

### BRIEF DESCRIPTION OF THE DRAWINGS

FIG. 1 is a block diagram illustrating an exemplary computer search system according to the present invention.

FIG. 2 is an exemplary block diagram illustrating one embodiment of the present invention operable to conduct a product search.

FIG. 3 is an exemplary block diagram illustrating another embodiment of the present invention, operable to use publication information to improve web page ranking and enrich relevant content presented to users.

FIG. 4 is an exemplary block diagram illustrating yet another embodiment of the present invention, operable to use product information and product usage information to improve web page ranking and enrich relevant content presented to users.

FIG. 5 is an example of presentation used by an exemplary computer search system according to the present invention, wherein more content-related information and links are integrated with the ranked web pages.

### DETAILED DESCRIPTION OF THE INVENTION

One aspect of the present invention is a computer system, and in particular an Internet search system, which searches for web pages in accordance with a search query specified by a user through a user interface. The inventive Internet search system is operable to rank web pages more accurately and relevantly using additional concept-related information found outside the found web pages being ranked and the link structure associated with the found web pages.

The invention improves the relevancy of the found web pages presented to users by taking into account additional information relevant to the concept of the search query and the content of each retrieved page. The invention also provides users with additional relevant information, in addition to the found web pages by combining the additional content-related information with the ranked web pages in the final presentation of search results.

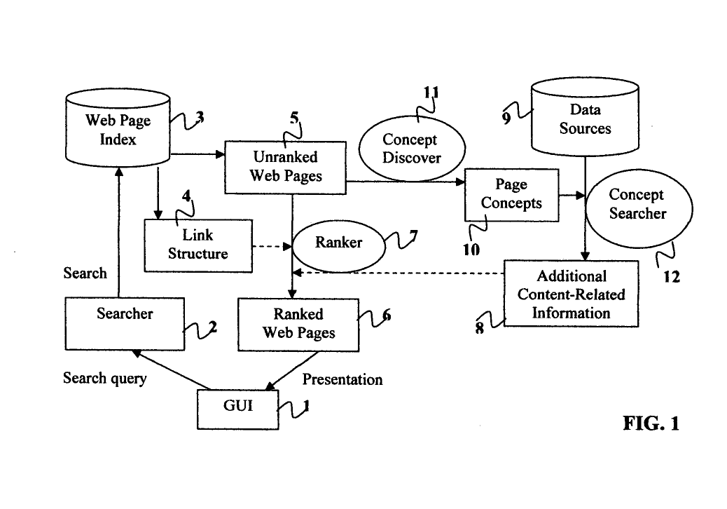

An exemplary computer system according to an embodiment of the present invention is described in more detail with reference to the drawings. However, the invention is not limited only to the disclosed embodiments or configurations. The system illustrated in FIG. 1 includes a Searcher 2 for processing the search query entered by the user through the Graphical User Interface (GUI) 1 and searching the Web Page Index 3 to produce a list of unranked collection of web pages 5. The Ranker 7 in the present invention, which is operable to sort the Unranked Web Pages 5 into a collection of Ranked Web Pages 6 is different from the existing ones. Unlike the existing page rankers that primarily use information on the Unranked Web Pages 5 and the Link Structure 4 that are directly related to the Unranked Web Pages 5, the Ranker 7 in the system in accordance with the present invention uses Additional Content-Related Information 8 with or without the information relating to the unranked collection of web pages 5 and/or the associated Link Structure 4.

Thus, the computer system under the present invention integrates an additional subsystem with a regular search engine. This subsystem has an additional Data Sources 9 and a new process to generate the Additional Content-Related Information 8 from the additional Data Sources 9 to be used in web page ranking. This new process conceptually consists of a Concept Discoverer 11 and a Concept Searcher 12. The Concept Discoverer 11 extracts the appropriate concepts relevant to the search queries from the resulted Unranked Web Pages 5. The Concept Searcher 12 searches the Data Sources 9 to find Additional Content-Related Information 8 related to the discovered Page Concepts 10 or the unranked web page contents.

The Data Sources 9 can be one or more data sources that contain information related to the contents of the retrieved web pages but not found directly on the web pages. Accordingly, the resulted Additional Content-Related Information 8 contains content-related information that differs from the web page information and the link information used in the existing ranking procedure.

In the computer system depicted in FIG. 1, the Ranker 7 uses the additional content-related information alone or together with one or more factors that are usually used for page ranking in the existing search systems. These factors include but not limited to query frequency and location on the web page, page metadata, inbound and outbound hyperlinks, and page access data. As a result, the ranking of the web pages is more relevant to the search query and the contents of the web pages.

In the computer system depicted in FIG. 1, the presentation of the Ranked Web Pages 6 to the user can be an ordered list of the web pages, in a similar manner to what is done in the existing search systems, or an ordered list of the web page along with the Additional Content-Related Information 8 found for each of the web pages.

Components 1 to 7 in FIG. 1 are usually considered together as a search engine. Another search engine component is web crawler, which is not shown in the figure. The web crawler is used to survey the web regularly and download desired web pages from any desirable web sites or web sites within a specific industry or interest area. The downloaded web pages are parsed and indexed to form the Web Page Index 3.

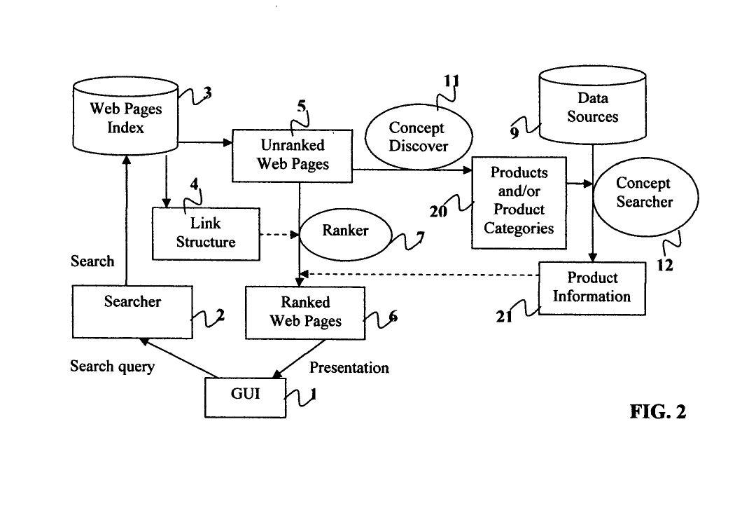

One embodiment of the computer system according to the present invention is an Internet search system for more effective product search. In such system as illustrated in FIG. 2, the Concept Discoverer 11 processes the Unranked Web Pages 5 and discovers the Products and/or Product Categories 20 on each of the web pages. Product discovery is done by natural language processing techniques and/or by correlation of the web page to pre-compiled product catalogs or taxonomies or databases or annotations of the web pages. The discovered Products and/or Product Categories 20 are used to search the Data Sources 9 to generate Product Information 21. The Data Sources 9 includes, but not limited to, publication database, product database and product usage database. The Product Information 21 includes but not limited to the number of publications related to the products and product usage data. Such Product Information 21 is then added to the ranking component (Ranker 7) for ranking the web pages. As a result, the top-ranked web pages are more relevant to products that are the objectives of the search query.

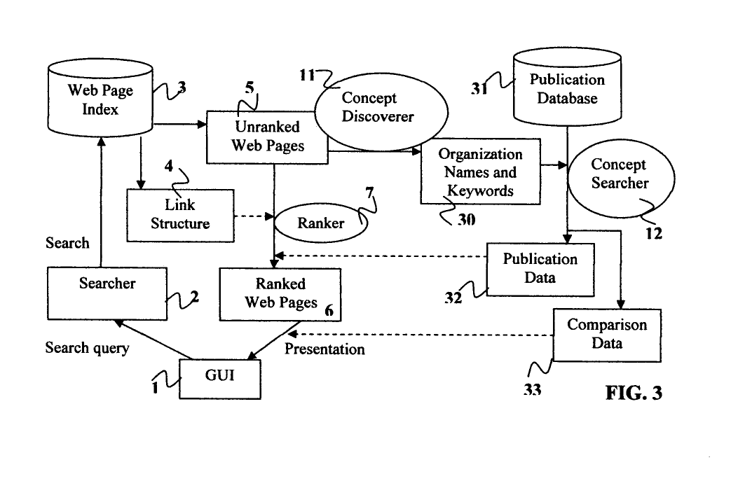

Another embodiment of the computer system according to the present invention is an Internet search system for information search, as illustrated in FIG. 3. In this system, the Concept Discoverer 11 discovers the Organization Names and Keywords 30 from each of the Unranked Web Pages 5. The organization names are the names of the entities who own or operate the web sites. The keywords are words and/or phrases that capture the concept of the search query and/or the content of the web page, including but not limited to the search terms entered by the user and keywords found on the web page or in the metadata of the page. The Concept Searcher 12 then uses the organization names coupled with the keywords to search one or more Publication Database 31. The resulted relevant Publication Data 32 is added to the ranking component (Ranker 7) for ranking the web pages. As a result, the top-ranked web pages are more relevant to products that are the objectives of the search query. Searching the Publication Database 31 can also provide content-related Comparison Data 33 for the organizations identified from the Unranked Web Pages 5, which is integrated into the search result presentation on the GUI.

The published data that form the Publication Database 31 can come from various sources, including but not limited to, scientific literatures published in scientific journals, articles and reviews in selected good quality industry trade journals, and selected reports and publications from governments, as well as data published on the semantic web. Semantic web data can be described using any of the standard languages including but not limited to XML, RDF and OWL. The publications include full-text articles and/or abstracts from various sources including publishers, literature aggregators, conferences, and the Internet. These publications are stored in their original formats and/or further processed into structured forms that are stored in a relational database or a database with indexed documents. The Publication Database 31 can be searched by any keywords.

The improved page ranking component (Ranker 7) in the above-described embodiment uses publication data directly related to the concept of a search query and the contents of the resulted web pages as the sole factor or a factor in conjunction with one or more regular factors to determine page ranking of the search results. These regular factors include but not limited to query frequency and location on the web page, page metadata, inbound and outbound hyperlinks, and page usage data. The publication data for a given web page includes but not limited to a count or a score or a weighted number representing a list of publications that are found related to the web page.

As an example, the search engine's crawler fetches RDF files on the Internet, some of which describe collaboration or partnership information or business deal information either as an instance of a class or a value of a property. These RDF files are parsed and the relevant data are stored in the Publication Database 31. When a user enters search query “collaboration on studying aging process”, the search engine first searches the Web Page Index 3 to retrieve a list of Unranked Web Pages 5. Next, the search engine also searches the Publication Database 31 using the Organization Names and Keywords 30 identified from the retrieved web pages. The numbers of collaborations about aging process published by or related to each organization (Publication Data 32) are used as a factor either alone or together with other ranking factors used by the Ranker 7 to rank the web pages in descending order. A hyperlink is also provided for each ranked web page listed on the search result page. Clicking this hyperlink will lead to a new page comparing the collaborations published in RDF from the organizations.

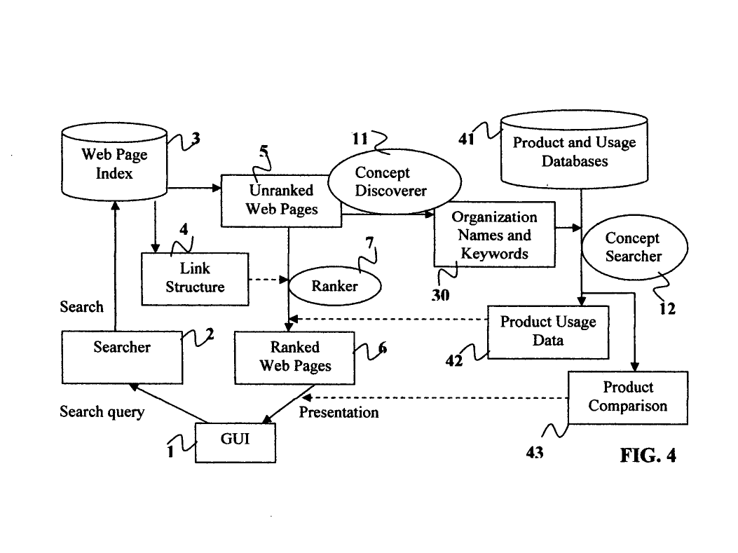

Another embodiment of the computer system according to the present invention is an Internet search system for product search, as illustrated in FIG. 4. In this system, the Concept Discoverer 11 finds the Organization Names and Keywords 30 from each of the Unranked Web Pages 5. The keywords are words and/or phrases that capture the concept of the search query and/or the content of the web page, including but not limited to the search terms entered by the user and keywords found on the web page or in the metadata of the page. The Concept Searcher 12 then uses the organization names coupled with the keywords to search one or more Product and Usage Database 41. The resulted additional information such as relevant Product Usage Data 42 is added to the ranking component (Ranker 7) for ranking the web pages. As a result, the top-ranked web pages are more relevant to products that are the objectives of the search query.

Searching the product database in 41 also identifies a list of related or competitive products (Product Comparison 43) from different product providers. This comparison of products can be presented to the user through a link that is associated with each resulted hit listed on the search result page. Clicking this link will bring up the list of product comparison.

The product database in 41 contains records of product information submitted from the manufacturers or fetched from manufacturers' websites. Manufacturers can submit or publish product information using various file formats including but not limited to tab-delimited text, XML, RDF or OWL, although semantic standard languages such as RDF or OWL are preferred formats. One or multiple ontologies designed for modeling products and manufacturers as well as related objects are usually used to publish product information in RDF or OWL. These ontologies should have classes or properties for describing product name, product model, product description, manufacturer, etc. These RDF or OWL files are parsed and the resulted product information are indexed by field or stored in relational database tables. This product database can be searched by any keywords.

The product usage database in 42 contains records for the usage of the products such as the number of use cases, product applications, users, and product trade information. Such information are obtained from various sources including (1) text mining of peer-reviewed publications, (2) submission from product providers, (3) parsing research information published in RDF or OWL as semantic content on the web, and (4) other existing product usage information databases. This product usage database can be searched by any keywords.

Research publications usually have a “methods and materials” section that lists tools or products such as reagents, instruments and software used in the research. Furthermore, the product and its manufacturer are usually mentioned in the same sentence. Thus, text mining software can be used to parse out the individual sentences from the methods and materials section in research articles. These sentences are indexed as database and can be searched by the search engine. When an organization name and keywords of a product match the same sentence, one point (or vote) is given to the product from this organization.

Similarly, when researches or experiments are published as RDF or OWL file on the web, the tools or products used in performing the research or experiments are described explicitly using a relevant ontology. By parsing these files, a search engine index or a relational database can be built to contain records indicating what products have been used in what experiment or research. When an organization name and keywords of a product match one record in such index or database, one point (or vote) is given to the product from this organization.

The improved page ranking component (Ranker 7) in the above embodiment uses product usage data directly related to the concept of a search query and the contents of the resulted web pages as the sole factor or a factor in conjunction with one or more regular factors to determine page ranking of the search results. These regular factors include but not limited to query frequency and location on the web page, page metadata, inbound and outbound hyperlinks, and page usage data. The product usage data for a given web page includes but not limited to accumulated points (or votes) for each of the product providers identified from the retrieved web pages. Such objective product usage information makes the final page ranking more relevant.

Another embodiment of the computer system according to the present invention is an Internet search system for product search that combines multiple additional data sources such as Publication Database 31 and Product and Usage Databases 41 in the above embodiments. In this system, the Concept Discoverer 11 finds the Organization Names and Keywords 30 from each of the Unranked Web Pages 5. The Concept Searcher 12 then uses the organization names coupled with the keywords to search two or more additional databases such as Publication Database 31 and Product and Usage Databases 41. The resulted additional information such as relevant Publication Data 32 and Product Usage Data 42 is added to the ranking component (Ranker 7) for ranking the web pages. As a result, the top-ranked web pages are more relevant to products that are the objectives of the search query.

In the above-described embodiments, the presentation of the Ranked Web Pages 6 includes links to the additional information found for each web page, including but not limited to publications, usage data and comparative data. Such integration of more relevant information in the final presentation of search results provides richer information for users to make better judgment of what web pages are relevant to the search.

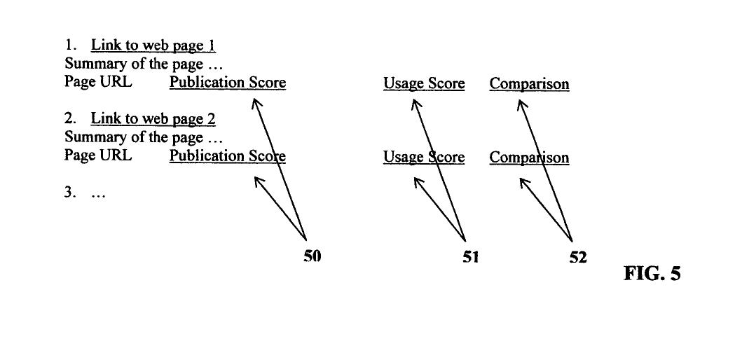

As an example illustrated in FIG. 5, each ranked web page is presented with one or more links of the followings when available:

Publication Score 50. A count or a weighted number or a score calculated from a list of publications found directly related to the search query and the web page. The number is linked to a page listing the publications. Different publications are weighted equally or differently according to the different publication sources.

Usage Score 51. A number or a score indicating the usage of the products found on or related to the web page. This number is linked to a page listing the publication sources that use the products.

Comparison 52. A link to a web page that compares the relevant information or product information found in the additional data sources.

Although the present invention has been described above by way of the preferred embodiments thereof, various changes and modifications will be apparent to those having ordinary skill in the art. Therefore, unless otherwise these changes and modifications depart from the scope of the present invention, they should be construed as included therein.

What is claimed is:

1. An Internet search system comprising:
a. a web crawler operable to retrieve a collection of web pages from an Internet;
b. a database comprising indexed collection of web pages;
c. a user interface operable to receive a search query;
d. a search module operable to search the database for web pages matching the search query and to retrieve the matching web pages from the database;
e. a ranking module operable to rank the retrieved matching web pages, and
f. a subsystem comprising:
i. a first module operable to identify concepts of the retrieved matching web pages;
ii. at least one data source comprising independent information not present in the retrieved matching web pages and in a link structure associated with the retrieved matching web pages;
iii. a second module operable to search the at least one data source for the identified concepts and to generate an additional concept-related information, wherein the ranking module ranks the retrieved matching web pages based on the additional concept-related information; and
iv. a presenter module operable to integrate the additional concept-related information with the retrieved matching web pages.

2. The Internet search system of claim 1, wherein the concepts of the retrieved matching web pages comprise at least one of a group consisting of: organization names, keywords identified from the search query and keywords identified from the retrieved matching web pages.

3. The Internet search system of claim 1, wherein the at least one data source comprises:
a. a first database containing journal articles, industry publications, and government publications;
b. a second database containing semantic web data published in a semantic web language; and
c. a third database containing information parsed from at least one of the first database and the second database using text mining processing techniques, natural language processing techniques or semantic data parsers.

4. The Internet search system of claim 1, wherein the additional concept-related information comprises at least one of scores of matched publications, counts of matched publications, and comparative data parsed from the matched publications.

5. The internet search system of claim 1, wherein the ranking module is operable to rank pages based on the additional concept-related information or the additional concept-related information in combination with information on at least one of query frequency on the web page, query location on the web page, page metadata, inbound hyperlinks, outbound hyperlinks, and page usage data.

6. The Internet search system of claim 1, wherein the presenter module is operable to integrate at least one of two hyperlinks into the search result page for each of the retrieved matching web pages, a first hyperlink pointing to a list of matching publications and a second hyperlink pointing to a list of comparative data parsed from the matching publications.

7. An Internet search system comprising:
a. a web crawler operable to retrieve a collection of web pages from an Internet;
b. a database comprising indexed collection of web pages;
c. a user interface operable to receive a search query from a user;
d. a search module operable to search the database for web pages matching the search query and to retrieve the matching web pages from the database;
e. a ranking module operable to rank the retrieved matching web pages, and
f. a subsystem comprising:
i. a first module operable to identify concepts of the retrieved matching web pages;
ii. at least one data source comprising independent information not present in the retrieved matching web pages and in a link structure associated with the retrieved matching web pages;
iii. a second module operable to search the at least one data source for the identified concepts and to generate an additional product related information, wherein the ranking module ranks the retrieved matching web pages based on the additional product related information; and
iv. a presenter module operable to integrate the additional product related information with the list of retrieved web pages.

8. The Internet search system of claim 7, wherein the matching web page concepts comprise at least one of products and product categories described in the retrieved matching web pages.

9. The Internet search system of claim 7, wherein the matching web page concepts comprise at least one of organization names, keywords identified from the search query and keywords identified from the retrieved matching web pages.

10. The Internet search system of claim 7, wherein the data sources comprises at least one of a product database and a product usage database.

11. The Internet search system of claim 7, wherein the at least one data source comprises:
a. a first database containing journal articles, industry publications, and government publications;
b. a second database containing semantic web data published in a semantic web language; and
c. a third database containing information parsed from at least one of the first database and the second database using text mining processing techniques, natural language processing techniques or semantic data parsers.

12. The Internet search system of claim 7, wherein the additional product related information comprises at least one of scores of product usage, counts of product usage, scores of matched publications, and scores of comparative product information.

13. The internet search system of claim 7, wherein the ranking module is operable to rank pages based on the additional product related information or the additional product related information in combination with information on at least one of query frequency on the web page, query location on the web page, page metadata, inbound hyperlinks, outbound hyperlinks, and page usage data.

14. The Internet search system of claim 7, wherein the presenter module is operable to integrate at least one of three hyperlinks into the search result page for each of the retrieved matching web pages, a first hyperlink pointing to a list of matching publications, a second hyperlink pointing to a list of matching product usage publications, and a third hyperlink pointing to a list of comparative products parsed from the matching publications.

15. A process for a web search engine comprising:
a. creating a product usage database based on a collection of publications; and
b. utilizing the created product usage database to rank at least one of web pages, product providers, and products.

16. The process of claim 15, wherein creating the product usage database based on a collection of publications comprises parsing contents of the publications using at least one of text mining processing, natural language processing, and semantic data parsing to extract information on products that are used in each of the publications, and organizing the extracted information in at least one database that is ready to be searched by a search engine.

17. The process of claim 15, wherein the publications comprise at least one of journal articles, research papers, industry magazine articles, industry reports, government reports, and research information published as semantic web data published in a semantic web language.

18. The process of claim 15, wherein utilizing a product usage database comprises searching the product usage database for at least one of a product name, a product category, a keyword, a phrase and an organization name that is identified from each of the web pages to obtain at least one of a product usage score or a product usage count, and ranking the web pages according to the at least one of product usage score and product usage count.

19. The process of claim 15, wherein utilizing a product usage database comprises searching the product usage database for a query entered by a user and an organization name that is identified from each of the web pages to obtain at least one of a product usage score or a product usage count, and ranking the web pages according to the at least one of product usage score and product usage count.

20. The process of claim 15, wherein utilizing a product usage database comprises searching the product usage database for at least one of a product name, a product category and a query entered by a user to obtain a product comparison data, and ranking at least one of the products and the product providers according to the product comparison data.
